(19) United States
(12) Patent Application Publication
(10) Pub. No.: US 2018/0140071 A1
(43) Pub. Date: May 24, 2018

(54) COSMETIC IMPREGNATION DEVICE

(71) Applicant: SAMWHA PLASTIC IND.CO., Uiwang-si (KR)

(72) Inventors: Sung-Hwan CHO, Seoul (KR); Geun JANG, Gunpo-si (KR); Kyung-Chang LEE, Uiwang-si (KR)

(73) Assignee: SAMWHA PLASTIC IND.CO.

(21) Appl. No.: 15/874,897

(22) Filed: Jan. 19, 2018

Related U.S. Application Data
(63) Continuation of application No. PCT/KR2016/002559, filed on Mar. 15, 2016.

(30) Foreign Application Priority Data
Jul. 20, 2015 (KR) 10-2015-0102118

(51) Int. Cl. A45D 33/02; A45D 33/00; A45D 34/00; B32B 5/02; B32B 27/36

(52) U.S. Cl. CPC A45D 33/02; A45D 33/006; A45D 34/00; B32B 2555/00; B32B 27/36; B32B 2307/72; B32B 5/028

(57) ABSTRACT

Various embodiments related to a cosmetic impregnation device have been described. According to one embodiment thereof, the cosmetic impregnation device comprises: an impregnation member consisting of a nonwoven fabric; and at least one antimicrobial mesh member attached to both sides of the impregnation member. In addition, various other embodiments are possible.

### PRIORITY

This application is continuation of International Application No. PCT/KR2016/002559 filed on Mar. 15, 2016, which claims priority to Korean Application No. 10-2015-0102118 filed on Jul. 20, 2015, which applications are incorporated herein by reference.

### BACKGROUND ART

### 1. Field of the Disclosure

The present disclosure relates to a cosmetic impregnation device used for make-up.

### 2. Description of the Related Art

In general, cosmetic contents are in various forms such as powder, liquid, gel, cream, and solid. These cosmetic contents are contained and used in various cosmetic containers.

For commercialization, cosmetic contents are contained in a portable container having a puff, so that a user may use the cosmetic contents at any time in any place. As the cosmetic contents pass through a mesh in the container, the discharge amount of the cosmetic contents is simultaneously adjusted. That is, the user grabs the puff and contacts the puff with the mesh, and at the same time, the cosmetic contents of the container are applied on the puff. Herein, an impregnation member impregnated with the cosmetic contents is provided inside the container.

The structure of a cosmetic container will be described below. The cosmetic container includes a container body for accommodating an impregnation member impregnated with cosmetic contents, and a lid including a middle cap which is provided inside a top end of the cosmetic container and includes a mesh for discharging the cosmetic contents, and a sealing cap which is engaged with the top end of the container body in an openable and closable manner to seal the middle cap, and configured to seal and expose the mesh.

The impregnation member may be impregnated with the cosmetic contents, thereby facilitating use of high-viscosity cosmetic contents. This impregnation member is formed of polyurethane sponge.

However, the impregnation member provided in the conventional cosmetic container is configured to contact a puff that touches the skin of a user or to directly contact the user's hand. Therefore, if the impregnation member is used for a long time, the cosmetic contents in the impregnation member are contaminated and changed due to bacterial growth.

Accordingly, there is a need for a device for preventing easy contamination of cosmetic contents by inhibiting bacterial growth caused by prolonged use of the cosmetic contents impregnated into an impregnation member.

### SUMMARY

An aspect of the present disclosure is to provide a cosmetic impregnation device including at least one antimicrobial mesh member having an antimicrobial/bacteriostatic function, attached to both surfaces of an impregnation member including a felt, so that even though cosmetic contents are used for a long time, bacterial and microbiological growth may be prevented and thus the cosmetic contents may be used and maintained clean.

In accordance with an aspect of the present disclosure, a cosmetic impregnation device may include an impregnation member including a felt, and at least one antimicrobial mesh member attached on both surfaces of the impregnation member.

### BRIEF DESCRIPTION OF THE DRAWINGS

FIG. 1a is a plan view illustrating an impregnation member in a cosmetic impregnation device according to various embodiments of the present disclosure.

FIG. 1b is a side view illustrating the impregnation member in the cosmetic impregnation device according to various embodiments of the present disclosure.

FIG. 2 is an exploded perspective view illustrating the cosmetic impregnation device according to various embodiments of the present disclosure.

FIG. 3a is a plan view illustrating an assembled state of the cosmetic impregnation device according to various embodiments of the present disclosure.

FIG. 3b is a side view illustrating the assembled state of the cosmetic impregnation device according to various embodiments of the present disclosure.

### DETAILED DESCRIPTION

Terms used in various embodiments of the present disclosure will be described in brief, followed by a detailed description of various embodiments of the present disclosure.

Although the terms used in the embodiments of the present disclosure are selected from widely used general terms in consideration of functions in the embodiments of the present disclosure, the terms may be changed according to the intention of those skilled in the art, customs, or emergence of new technologies. In addition, the applicant selects some terms in a specific case, and the meanings of the terms are described in detail in the description of various embodiments of the present disclosure. Therefore, the present disclosure should be understood, not simply by the actual terms used but by the meanings of each term lying within.

Ordinal terms such as first or second may be used to describe, not limiting, various components. These expressions are used to distinguish one component from another component. For example, a first component may be referred to as a second component, and vice versa without departing from the scope of the present disclosure. Cosmetic contents are one of liquid cosmetic contents and powder cosmetic contents. While liquid cosmetic contents and powder cosmetic contents are described, by way of example in an embodiment of the present disclosure, the present disclosure is not limited thereto. That is, the cosmetic contents may be in a form other than liquid and powder. Herein, the embodiment will be described in the context of powder cosmetic contents.

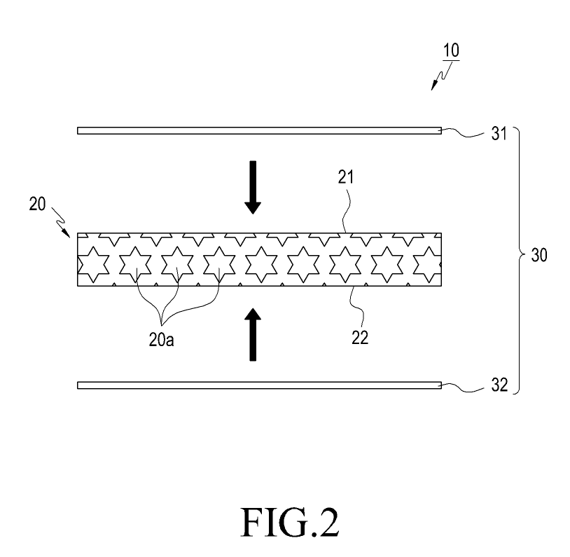

FIG. a is a plan view illustrating an impregnation member 20 in a cosmetic impregnation device 10 according to various embodiments of the present disclosure, FIG. a is a side view illustrating the impregnation member 20 in the cosmetic impregnation device 10 according to various embodiments of the present disclosure, and FIG. 2 is an exploded perspective view illustrating the cosmetic impregnation device according to various embodiments of the present disclosure.

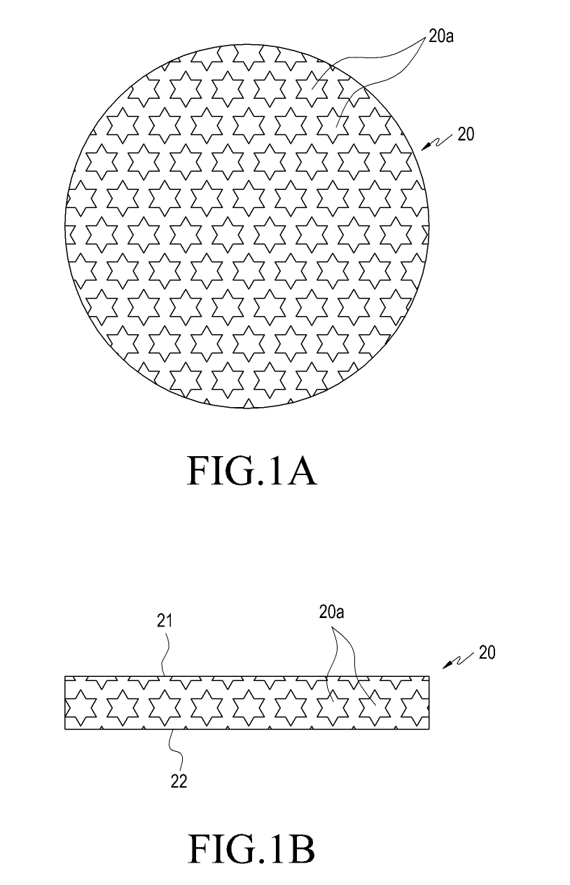

With reference to FIGS. 1a, 1b, and 2, the structure of the cosmetic impregnation device 10 will be described. As illustrated in FIGS. 1a, 1b, and 2, the cosmetic impregnation device 10 may include the impregnation member 20 including felts 20a, and at least one antimicrobial mesh member 30.

The impregnation member 20 may be fabricated in a vertical weaving method (vertical lap) to impart elasticity to the felts 20a. The antimicrobial mesh member 30 may be attached on both surfaces of the impregnation member 20 to execute an antimicrobial/bacteriostatic function for the impregnation member 20.

The felts 20a refer to fabrics produced by bonding or matting fibers through mechanical manipulation, thermal bonding, or use of a chemical agent. The impregnation member 20 including the felts 20a is in a similar structure to that for a bed mattress, thereby having excellent restorability and durability.

As described above, since the impregnation member 20 is fabricated in the vertical weaving method (vertical lap) to impart elasticity to the felts 20a, use of high-viscosity cosmetic contents (foundation, make-up base, and BB cream) may be facilitated, and the cosmetic contents may be faster impregnated than in the case of using a conventional impregnation member (not shown) formed of sponge. Further, as the at least one antimicrobial mesh member 30 having the antimicrobial/bacteriostatic function is attached on both surfaces of the impregnation member 20 according to the embodiment, even though the cosmetic contents are used over a long term, bacterial and microbiological growth is prevented, thereby allowing clean use and maintenance of the cosmetic contents.

Further, when the cosmetic contents are smeared on a uniform contact surface of the antimicrobial mesh member 30, cosmetic particles and the cosmetic contents may be applied uniformly across a puff. As a consequence, make-up convenience of a user may be increased.

Further, the felts 20a may be formed of polyester. While the felts 20a are described as formed of polyester by way of example in the embodiment, the present disclosure is not limited thereto. That is, any material is available for the felts 20a, as far as the material is excellent in terms of restorability and durability.

Further, the density of the felts 20a may be 240 to 250 g/sqm.

Further, the at least one antimicrobial mesh member 30 will be described below in greater detail. As illustrated in FIG. 2, the at least one antimicrobial mesh member 30 may include first and second antimicrobial mesh members 31 and 32. The first antimicrobial mesh member 31 may be attached on a first surface 21 of the impregnation member 20 in order to execute the antimicrobial/bacteriostatic function. The second antimicrobial mesh member 32 may be attached on a second surface 22 of the impregnation member 20, opposite to the first surface 21.

Therefore, as described before with reference to FIG. 2, the first and second antimicrobial mesh members 30 may be attached on the top and bottom surfaces of the impregnation member 20.

Further, the first and second antimicrobial mesh members 30 may be attached on the first and second surfaces of the impregnation member 20 by an adhesive (not shown) or thermal fusion.

The adhesive (not shown) may be a hot melt adhesive. In the embodiment, an adhesive other than the hot melt adhesive may be used. For example, the adhesive may be a silicon adhesive.

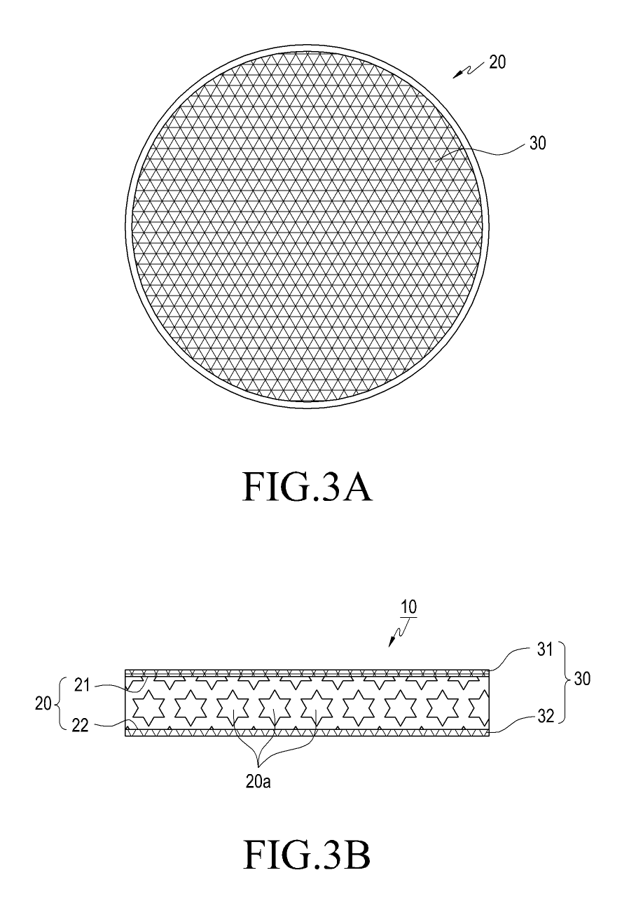

Now, a description will be given of assembly of the cosmetic impregnation device 10. FIG. 3a is a plan view illustrating an assembled state of the cosmetic impregnation device according to various embodiments of the present disclosure, and FIG. 3b is a side view illustrating the assembled state of the cosmetic impregnation device according to various embodiments of the present disclosure.

As described before with reference to FIG. 2, the cosmetic impregnation device 10 may include the impregnation member 20 including the felts 20a, and the first and second antimicrobial mesh members 30.

As illustrated in FIGS. 3a and 3b, an adhesive (not shown) is coated on the first and second surfaces 21 and 22 of the impregnation member 20, and the first and second antimicrobial mesh members 30 are attached onto the first and second surfaces 21 and 22.

Further, the first and second antimicrobial mesh members 30 may be brought into close contact with the first and second surfaces 21 and 22 of the impregnation member 20, and the first and second antimicrobial mesh members 31 and 32 may be attached onto the first and second surfaces 21 and 22 by thermal fusion. As described above, the antimicrobial mesh members 31 and 32 may be attached onto the first and second surfaces 21 and 22 of the impregnation member 20 by an adhesive or thermal fusion.

The thus-completed impregnation device 10 is accommodated in a cosmetic container (not shown) and impregnated with cosmetic contents (not shown). The impregnation device 10 may be filled with cosmetic contents, and when the impregnation device 10 is completely impregnated with the cosmetic contents, a user smears the cosmetic contents on a puff (not shown) and uses the smeared puff. Herein, the cosmetic contents are smeared uniformly across the puff of the user.

The puff (not shown) smeared with the cosmetic contents is applied to the skin of the user, and is smeared with the cosmetic contents and used a plurality of times. Herein, the puff touching the skin of the user contacts germs on the skin, and these germs are introduced into the cosmetic contents of the impregnation device 10, simultaneously with contacting the cosmetic contents. The germs introduced into the cosmetic contents of the impregnation device 10 are exterminated by the first and second antimicrobial mesh members 31 and 32 having the antibacterial/bacteriostatic function. That is, since the first and second antimicrobial mesh members 31 and 32 have the antibacterial/bacteriostatic function, bacterial growth may be prevented as well as germs introduced into the cosmetic contents may be exterminated. As a consequence, even though the cosmetic contents are used for a long time, the cosmetic contents may be used and maintained clean without microbial growth.

According to various embodiments of the present disclosure, since an impregnation member is fabricated in a vertical weaving method (vertical lap) to impart elasticity to a felt, use of high-viscosity cosmetic contents is facilitated, and the impregnation speed of the cosmetic contents is much increased, compared to a conventional sponge impregnation member. Further, at least one antimicrobial mesh member having an antimicrobial/bacteriostatic function is attached to both surfaces of the impregnation member. Therefore, even though the cosmetic contents are used for a long time, bacterial and microbiological growth in the cosmetic contents is prevented and thus the cosmetic contents may be used and maintained clean.

The above-described cosmetic impregnation device according to various embodiments of the present disclosure is not limited by the foregoing embodiments and the drawings. Thus, it will be obvious to those skilled in the art that many replacements, modifications, and alterations can be made to the present disclosure within the scope and spirit of the present disclosure.

What is claimed is:

1. A cosmetic impregnation device comprising:
an impregnation member including a felt; and
at least one antimicrobial mesh member attached on both surfaces of the impregnation member.

2. The cosmetic impregnation device of claim 1, wherein the impregnation member is fabricated in a vertical weaving method (vertical lap) to impart elasticity.

3. The cosmetic impregnation device of claim 1, wherein the felt is formed of polyester.

4. The cosmetic impregnation device of claim 1, wherein the felt has a density of 240 to 250 g/sqm.

5. The cosmetic impregnation device of claim 1, wherein the at least one antimicrobial mesh member includes a first antimicrobial mesh member and a second antimicrobial mesh member, and
wherein the first antimicrobial mesh member is attached on a first surface of the impregnation member, and the second antimicrobial mesh member is attached on a second surface of the impregnation member, opposite to the first surface.

6. The cosmetic impregnation device of claim 1, wherein the at least one antimicrobial mesh member is attached to the impregnation member by an adhesive or thermal fusion.

7. The cosmetic impregnation device of claim 6, wherein the adhesive is a hot melt adhesive.
